(19) United States
(12) Patent Application Publication
(10) Pub. No.: US 2025/0163958 A1
(43) Pub. Date: May 22, 2025

(54) A HYDRODYNAMIC SLIDING BEARING

(71) Applicant: Miba Bearings US, LLC, McConnelsville, OH (US)

(72) Inventor: Rick WALKER, McConnelsville, OH (US)

(73) Assignee: Miba Bearings US, LLC, McConnelsville, OH (US)

(21) Appl. No.: 18/839,505

(22) PCT Filed: Mar. 18, 2022
(86) PCT No.: PCT/IB2022/052464

§ 371 Date: Aug. 19, 2024

Related U.S. Application Data
(60) Provisional application No. 63/311,187, filed on Feb. 17, 2022.

(51) Int. Cl. F16C 17/02

(52) U.S. Cl. CPC F16C 17/026

(57) ABSTRACT

A hydrodynamic sliding bearing includes an inner ring element and an outer ring element. The inner ring element and the outer ring element are rotatable relative to each other about an axis of rotation. Either the inner ring element or the outer ring element has a sliding surface and the other one of the inner ring element or the outer ring element has a counter surface corresponding with the sliding surface. The sliding surface has a non-circular shaped cross section and is tapered in axial extension.

The invention relates to a hydrodynamic sliding bearing.

In the past, engineers tried to incorporate both an axial bearing and radial bearing into one bearing using either a cone shape or a spherical shape. An example for such a hydrodynamic bearing with radial, thrust and moment load capacity is described in the prior art document U.S. Pat. No. 4,243,274A.

The layout as described in U.S. Pat. No. 4,243,274A has the disadvantage that under high axial loads, the shaft will become concentric to the bearing and no wedge shape of the oil can be formed. Therefore, no hydrodynamic pressure can be generated, which leads to a contact of a sliding surface and a counter surface and the wear of the bearing increases dramatically. Only under low axial loads, the shaft and bearing stay eccentric and allow an oil film to form a traditional wedge shape to allow for hydrodynamic pressure to be generated.

The objective technical problem of the present invention was to provide an improved hydrodynamic bearing that can carry high radial loads and that can also carry high axial loads. Until the invention was made, it was the technical prejudice that a hydrodynamic bearing cannot be designed to carry high radial loads and also high axial loads.

The solution of the objective technical problem is achieved by a hydrodynamic sliding bearing according to the claims.

According to an embodiment the invention, a hydrodynamic sliding bearing is provided. The hydrodynamic sliding bearing comprises:
an inner ring element;
an outer ring element, wherein the inner ring element and the outer ring element are rotatable relative to each other about an axis of rotation;
wherein either the inner ring element or the outer ring element has a sliding surface and the other one of the inner ring element or the outer ring element has a counter surface corresponding with the sliding surface,
wherein the sliding surface has a non-circular shaped cross section and is tapered in axial extension. In other words, the non-circular shaped cross section is tapered in axial direction.

The features as mentioned above have the surprising effect, that the hydrodynamic sliding bearing can transmit high radial loads and high axial loads. The hydrodynamic wedge can be maintained in various conditions. This leads to an improved wear performance. Also, the efficiency of the hydrodynamic sliding bearing can be increased in the event of high axial loads because hydrodynamic oil film pressure can be maintained in the event of high axial loads.

The tapering of the sliding surface can be continuous. In an embodiment the sliding surface can be tapered in form of a cone segment. In another embodiment the sliding surface can be tapered in form of a sphere segment. In an other embodiment the tapering could also be in form of non-continuous shapes or combined shapes.

Another definition of a sliding surface that is tapered in axial extension could be that the diametral distance of the sliding surface at a first axial position is greater than the diametral distance of the sliding surface at a second axial position.

The non-circular shaped cross section of the sliding surface could in other words be described as having a non-rotational-symmetrical appearance.

The non-circular shaped cross section has the advantage, that in combination with the tapering in axial extension, even if high axial loads occur, it can be reached that a sufficient lubricating wedge can build up between the sliding surface and the counter surface, such that sufficient lubrication of the hydrodynamic sliding bearing can be reached.

The counter surface can have a circular shaped cross section. In other words, the counter surface can have a rotational-symmetrical appearance.

Furthermore, it may be useful if the cross section of the sliding surface comprises a first lobe and a second lobe, wherein in axial extension, the first lobe has a varying first radial distance to the axis of rotation. In other words, each of the lobes could be tapered in axial extension.

Furthermore, it may be provided that the first lobe and the second lobe when viewed in cross-section are shaped as fixed circular arc segments. A sliding surface of this configuration could have the advantage that the efficiency of the hydrodynamic sliding bearing could be further improved. The lobes could each have a circular shape, wherein the cross-section of the sliding surface could have a non-continuous circular shape or a segmented circular shape.

Moreover, it may be provided that when viewed in the cross-section each one of the lobes has an offset or tilt to the axis of rotation. A sliding surface of this configuration could have the advantage that the efficiency of the hydrodynamic sliding bearing could be further improved.

According to an advancement, it is possible that the first lobe and the second lobe are separated by a lubricant supply groove extending in axial direction. Such an lubricant supply groove could bring the advantage that sufficient lubricant for building up a hydrodynamic wedge can be supplied to the sliding surface.

The lubricant supply groove could be situated near a location, where lobe geometry begins to naturally increase the radial distance between mating surfaces, thus creating sufficient clearance to allow the lubricating fluid to flow sufficiently to lubricate the sliding surface and the counter surface at high pressure locations.

In particular, the lubricant supply groove, viewed in the direction of rotation, can be located directly behind the point at which the highest pressure of the lubrication fluid occurs.

In one embodiment it is possible that the sliding surface comprises the first lobe and the second lobe and that between the first lobe and the second lobe a first lubricant supply groove and a second lubricant supply groove are situated.

In another embodiment, it is possible that the sliding surface comprises the first lobe and the second lobe and a third lobe. Between the first lobe and the second lobe a first lubricant supply groove could be situated. Between the second lobe and the third lobe a second lubricant supply groove could be situated. Between the third lobe and the first lobe a third lubricant supply groove could be situated. Mutatis mutandis to this pattern, the sliding surface could comprise a plurality of lobes.

An embodiment, according to which it may be provided that a plurality of lubricant supply grooves are distributed as a regular circular pattern over the circumference of the sliding surface, is also advantageous. Such a pattern helps to increase the efficiency of the hydrodynamic sliding bearing.

According to an advantageous advancement, it may be provided that the lubricant supply groove extends over the entire axial direction of the sliding surface. Such features enable to increase the efficiency of the hydrodynamic sliding bearing, because the hydrodynamic effect an be reached over the whole axial extension of the sliding surface.

Furthermore, it may be useful if a lubricant distribution groove overlies the lubricant supply groove, the lubricant distribution groove extending only partially in an axial extension of the sliding surface. This brings the advantage that a feed of the lubricant from external to the sliding surface can be enhanced.

It can also be provided, that lubricant supply bores are formed which open into the lubricant supply groove. In particular, the lubricant supply bores can open into the lubricant distribution groove.

Furthermore, it may be provided that the lubricant supply groove is formed by a kink or a step between the first lobe and the second lobe, wherein in axial direction an edge of the lubricant supply groove has a varying second radial distance to the axis of rotation. A stepped design can be reached by the first lobe and the second lobe being tilted or being in radial offset to each other. The sliding surface with such a stepped design brings advantages, when the hydrodynamic sliding bearing has only one intended direction of rotation, when in use.

In alternative to the stepped design, it is possible that the first lobe and the second lobe are symmetrical to each other with respect to the lubricant supply groove. Such a configuration brings the advantage, that the sliding surface with such a symmetrical design does not need to have one intended direction of rotation, when in use.

Moreover, it may be provided that the sliding surface is a closed surface in circumferential direction, or
that the sliding surface is a closed surface in circumferential direction, which is penetrated by lubricant supply bores. Such a design brings surprising advantages in efficiency.

According to an advancement, it is possible that the sliding surface is segmented in circumferential direction and comprises a first segment and a second segment, wherein the first segment and the second segment are seamlessly connected to each other. In particular it is possible that the breach between the first segment and the second segment lies in a circumferential distance to the lubricant supply groove.

An embodiment, according to which it may be provided that that the counter surface has a circular shaped cross section, which is tapered in axial direction, is also advantageous.

According to a particular embodiment, it is possible that the counter surface is tapered in axial direction in the form of a cone segment.

According to an alternative embodiment, it is possible that the counter surface is tapered in axial direction in the form of a spherical segment. This brings the advantage that such a configuration allows for tilt of the inner ring element relative to the outer ring element without edge loading.

According to a particular embodiment, it is possible that the sliding surface is tapered in axial direction in the form of a cone segment.

According to an alternative embodiment, it is possible that the counter surface is tapered in axial direction in the form of a spherical segment.

In an alternative embodiment, it is possible that the counter surface is tapered in axial direction in the form of a spherical segment combined with the form of a cone segment.

In an alternative embodiment, it is possible that the counter surface is tapered in axial direction in the form of any hyperbolic or other structure or combined structure forms.

According to an advantageous advancement, it may be provided that that the sliding surface is arranged on the inner ring element and has a convex shape in axial direction.

In an alternative embodiment it can be provided that the sliding surface is arranged on the inner ring element and has a concave shape in axial direction.

In an alternative embodiment it can be provided that the sliding surface is arranged on the outer ring element and has a convex shape in axial direction.

In an alternative embodiment it can be provided that the sliding surface is applied on the outer ring element and has a concave shape in axial direction.

Furthermore, it may be useful if the non-circular shaped cross section of the sliding surface has an elliptical shape, or
the non-circular shaped cross section of the sliding surface has an offset halved shape, or
the non-circular shaped cross section of the sliding surface has a pressure dam shape, or
the non-circular shaped cross section of the sliding surface has a multi-lobe shape, such as a three-lobe shape, a four-lobe shape, etc., or
the non-circular shaped cross section of the sliding surface has a multi-pocket shape.

According to a particular embodiment, it is possible that in a special longitudinal section plane, the sliding surface has a first radius, and the counter surface has a second radius, wherein the first radius and the second radius are offset to each other by a clearance, wherein the clearance has a magnitude which is in the range of 0.00005 to 0.002 multiplied by the first radius. In particular, it is of advantage when the clearance has a magnitude, which is in the range of 0.0009 to 0.0011 multiplied by the first radius. The offset has the advantage, that a lubrication film which has a constant film thickness as viewed in the special longitudinal section, can build up in the clearance. This increases the efficiency of the hydrodynamic sliding bearing. At the same time wear of the hydrodynamic sliding bearing can be reduced. The special longitudinal section plane can be situated on a minimum clearance point, which is located on an intersection of a lobe with a virtual base circle.

The special section plane can be located at a circumferential distance of (360° devided by the number of lobes multiplied by the tilt) to the lubricant supply groove. In other words, the tilt defines the design of the lobes.

If the tilt is 0.5, then the lobes are symmetrical, which means that the first lobe and the second lobe intersect seamless. This type of hydrodynamic slide bearing could be used, when the hydrodynamic slide bearing should allow rotation in both directions. The intersection of the first lobe and the second lobe defining the lubricant supply groove, could be in form of a kink in the surface.

If the tilt is lower or higher than 0.5, then the lobes are asymmetrical, which means that the lubricant supply groove, where the first lobe and the second lobe intersect, has a step. In particular, it is of advantage, when the tilt is in the range of 0.15 to 0.18. Such layouts have the advantage that the performance could be increased when the hydrodynamic slide bearing is rotated in a main direction. This means that hydrodynamic slide bearings with such a layout could be used in applications where only one direction of rotation occurs.

According to an advancement, for a three lobe bearing, it is possible that the special section plane is located at a circumferential distance of 10° to 30° to the lubricant supply groove. In particular, it is of advantage when the special section plane is located at a circumferential distance of 18° to 22° to the lubricant supply groove.

When viewed in direction of rotation, the special section plane of a three lobe bearing can be located at a circumferential distance of 10° to 30° behind the lubricant supply groove. This layout could be applied to a hydrodynamic sliding bearing that has one main direction of rotation.

According to an embodiment of the invention a hydrodynamic sliding bearing is provided. The hydrodynamic sliding bearing comprises:
an inner ring element;
an outer ring element, wherein the inner ring element and the outer ring element are rotatable relative to each other about an axis of rotation;
wherein either the inner ring element or the outer ring element has a sliding surface and the other one of the inner ring element or the outer ring element has a counter surface corresponding with the sliding surface,
wherein the sliding surface is tapered in axial direction,
wherein the sliding surface comprises at least two lobes which extend on the tapered sliding surface in axial direction.

According to an embodiment of the invention a hydrodynamic sliding bearing is provided. The hydrodynamic sliding bearing comprises:
an inner ring element;
an outer ring element, wherein the inner ring element and the outer ring element are rotatable relative to each other about an axis of rotation;
wherein either the inner ring element or the outer ring element has a sliding surface and the other one of the inner ring element or the outer ring element has a counter surface corresponding with the sliding surface,
wherein the sliding surface comprises a first non-circular shaped profile and a second non-circular shaped profile being in axial offset to each other, wherein the first non-circular shaped profile and the second non-circular shaped profile are of different dimensions, wherein the sliding surface is extruded along guide rails between the first non-circular shaped profile and a second non-circular shaped profile.

Furthermore, it may be useful if
the first non-circular shaped profile and the second non-circular shaped profile of the sliding surface have an elliptical shape, or
the first non-circular shaped profile and the second non-circular shaped profile of the sliding surface have an offset halved shape, or
the first non-circular shaped profile and the second non-circular shaped profile of the sliding surface have a pressure dam shape, or
the first non-circular shaped profile and the second non-circular shaped profile of the sliding surface have a multi-lobe shape, such as a three-lobe shape, a four-lobe shape, etc, or
the first non-circular shaped profile and the second non-circular shaped profile of the sliding surface have a multi-pocket shape.

The hydrodynamic sliding bearing, as described in this document, can be used for application in rotary assemblies that must support high radial loads and also high axial loads. Such an application can for example be for bearing helical gears. In particular such helical gears can be utilized in planetary gears.

The sliding surface of the hydrodynamic sliding bearing can be provided on an anti-frictional layer. The anti-frictional layer can be applied on a carrier layer.

In particular, the anti-frictional layer can consist of a plain bearing material, at least on the anti-frictional layer surface, which acts as the sliding surface. For example, the anti-frictional layer can be made from a material which is selected from a group comprising aluminum-based alloys, such as AlSn20Cu, AlZn4Si3, silver-based alloys or copper-based alloys, possibly with bismuth, bismuth-based alloys. The hardness of such a plain bearing material could be between 20 HV (0.001) to 40 HV (0.001) for tin-based babbitts. For plain bearing material comprising aluminum, the hardness could be 40 HV (0.001) to 70 HV (0.001).

The anti-frictional layer can also be formed by an anti-frictional paint, whereby in this case the anti-frictional layer can have a hardness of between 25 HV (0.001) to 60 HV (0.001).

The anti-frictional paints used can be for example polytetrafluorethylene, resins containing fluorine, such as e.g. perfluoroalkoxy-copolymers, polyfluoroalkoxy-polytetrafluoroethylene-copolymers, ethylene-tetrafluoroethylene, polychlorotrifluoroethylene, fluorinated ethylene-propylene copolymers, polyvinyl fluoride, polyvinyl idene fluoride, alternating copolymers, statistical copolymers, such as e.g. perfluoroethylene propylene, polyester imides, bismaleimides, polyimide resins, such as e.g. carboranimides, aromatic polyimide resins, hydrogen-free polyimide resins, poly-triazo-pyromellithimides, polyamide imides, in particular aromatic, polyarylether imides, possibly modified by isocyanates, polyether imides, possibly modified by isocyanates, epoxy resins, epoxy resin esters, phenolic resins, polyamides 6, polyamides 66, polyoxymethylene, silicons, polyarylethers, polyaryl ketones, polyarylether ketones, polyarylether-ether ketones, polyether ether ketones, polyether ketones, polyvinylidene difluoride, polyethylene sulfides, allylene sulfide, poly-triazo-pyromellithimides, polyester imides, polyaryl sulfides, polyvinylene sulfides, polyphenylene sulfides, polysulfones, polyether sulfones, polyaryl sulfones, polyaryl oxides, polyaryl sulfides, as well as copolymers thereof.

An anti-frictional paint is preferable, which in a dry state comprises 40 wt. % to 45 wt. % MoS2, 20 wt. % to 25 wt. % graphite and 30 wt. % to 40 wt. % polyamide imide, whereby the anti-frictional paint can also comprise if necessary hard particles, such as e.g. oxides, nitrides or carbides in a proportion of a total of a maximum of 20 wt. % which replace a proportion of the solid lubricants.

The carrier layer can for example be made of steel or a copper-based alloy, in particular with zinc, for example CuZn31Si, CuSnZn, an AlZn or a CuAl alloy.

In one embodiment, the sliding surface and the counter surface could be designed as to have good dry running properties. In this case no additional oil pump is needed for a start or a slow down of the rotation.

In an alternative embodiment, the bearings can be lifted hydrostatic and can be switched by the specific control of a lubricant pump into operation with partial or full hydrodynamic lubrication.

In one embodiment, the sliding surface can be formed on a bushing, wherein the bushing is inserted between two parts that need to be rotated relative to each other. The counter surface can be formed on one of the two parts that need to be rotated relative to each other. In this case the bushing can be fixed to a shaft or pin, wherein the sliding surface is formed on the outer surface of the bushing. The bushing can also be fixed to a bore, wherein the sliding surface is formed on the inner surface of the bushing.

In an alternative embodiment, the sliding surface can directly be formed on one of the two parts that need to be rotated relative to each other and the counter surface can be formed on the other one of the two parts that need to be rotated relative to each other.

The sliding surface can be formed on the ring element that rotates. The sliding surface can also be formed on the ring element that is stationary.

The sliding surface can be made of a low-friction material. It is also possible that the counter surface is made of a low-friction material.

The lubricant used in the hydrodynamic sliding bearing can be an oil.

For the purpose of better understanding of the invention, it will be elucidated in more detail by means of the figures below.

These show in a respectively very simplified schematic representation:

FIG. 1 a longitudinal section of a first embodiment of an outer ring element and an inner ring element being assembled;

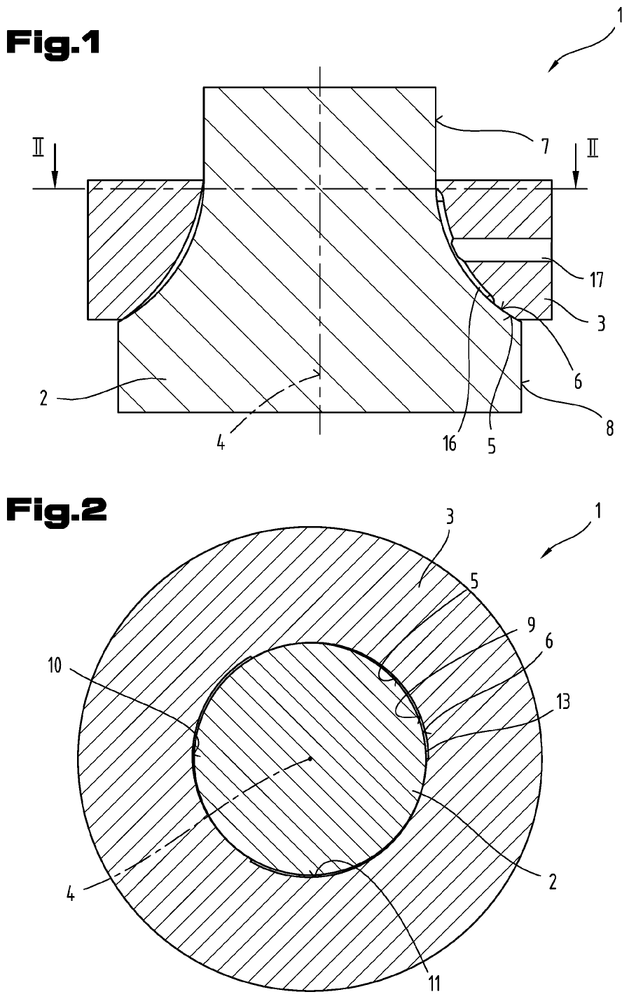

FIG. 2 a cross section of the first embodiment of the outer ring element and the inner ring element being assembled;

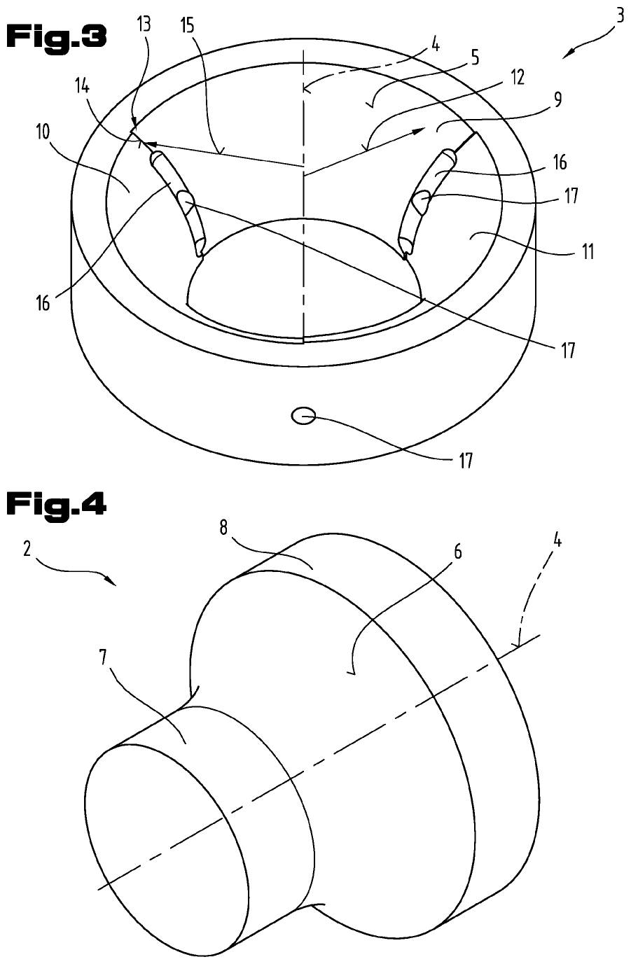

FIG. 3 a perspective view of the first embodiment of the outer ring element;

FIG. 4 a perspective view of the first embodiment of the inner ring element;

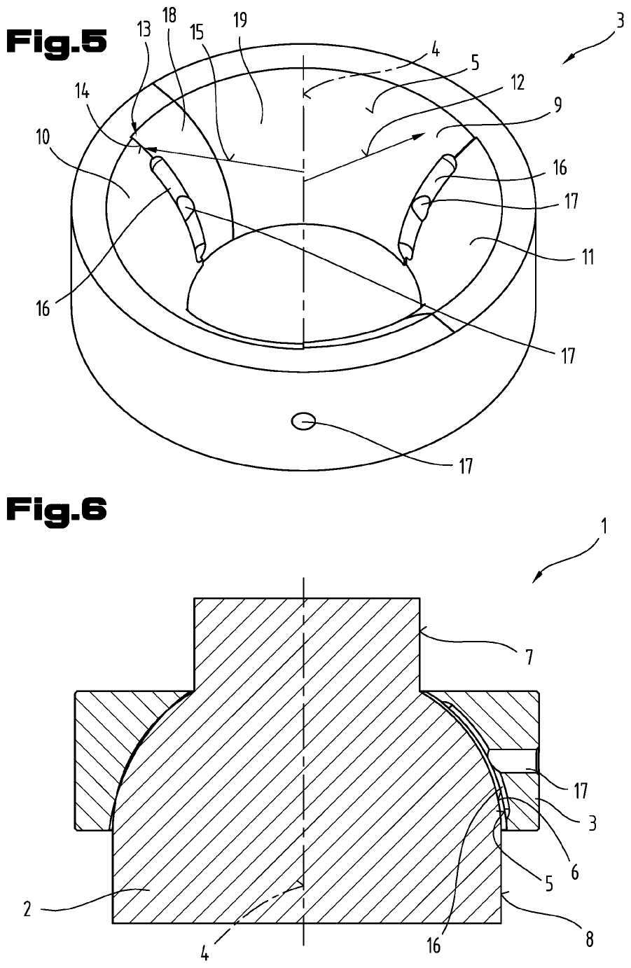

FIG. 5 a perspective view of a second embodiment of the outer ring element;

FIG. 6 a longitudinal section of a third embodiment of the outer ring element and the inner ring element being assembled;

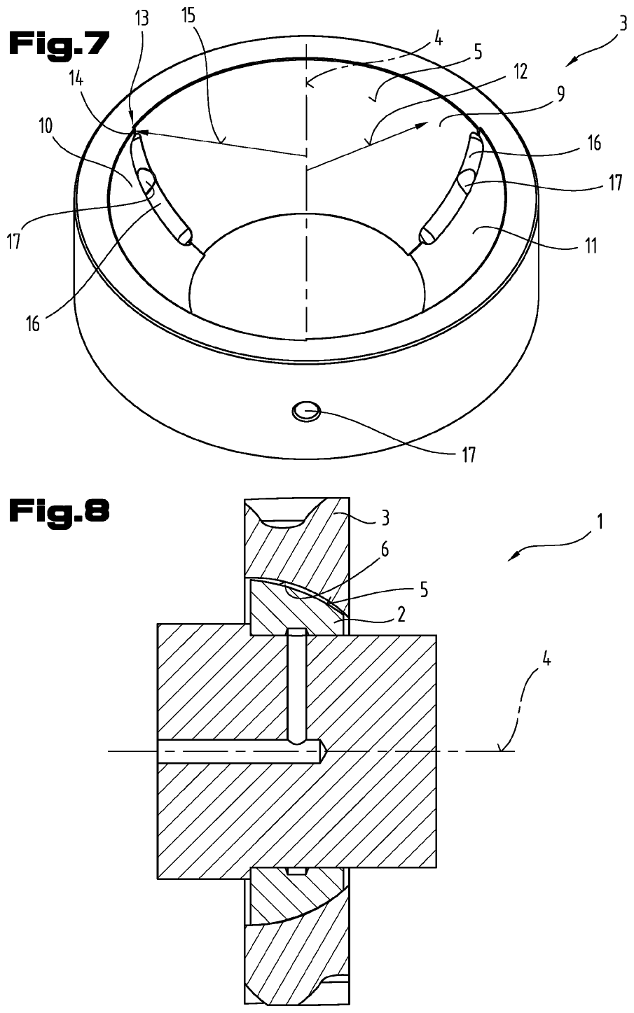

FIG. 7 a perspective view of the third embodiment of the outer ring element;

FIG. 8 a longitudinal section of a fourth embodiment of the outer ring element and the inner ring element being assembled;

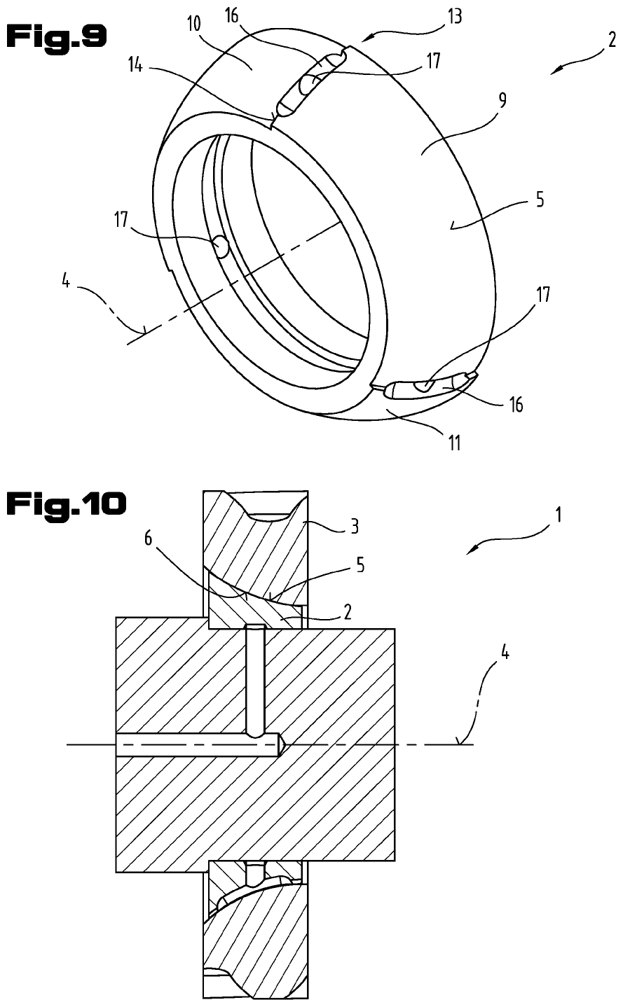

FIG. 9 a perspective view of the fourth embodiment of the inner ring element;

FIG. 10 a longitudinal section of a fifth embodiment of the outer ring element and the inner ring element being assembled;

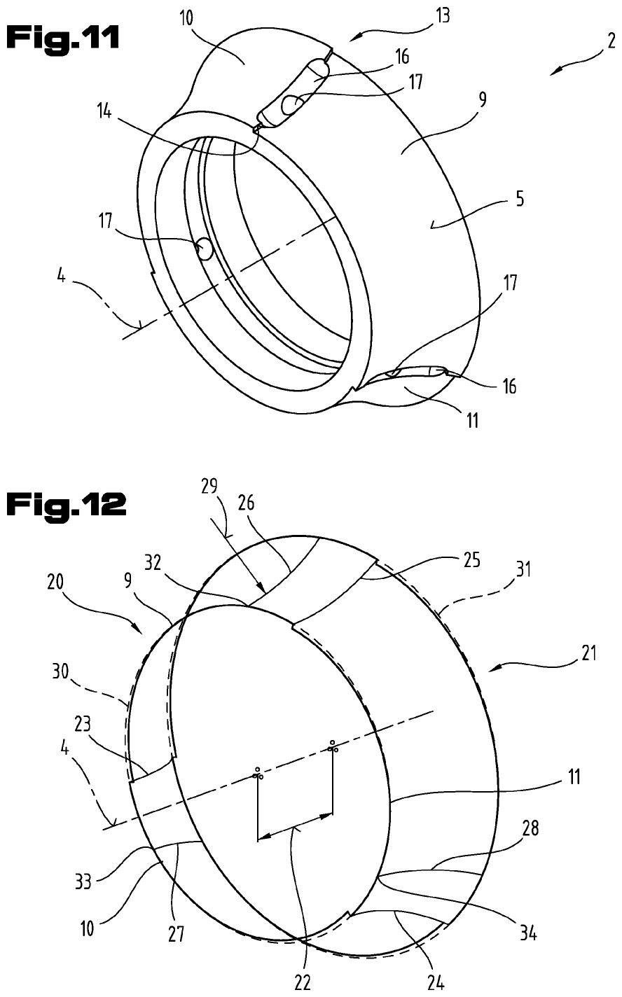

FIG. 11 a perspective view of the fifth embodiment of the inner ring element;

FIG. 12 a perspective view of the geometrical construction elements of the fifth embodiment of the inner ring element;

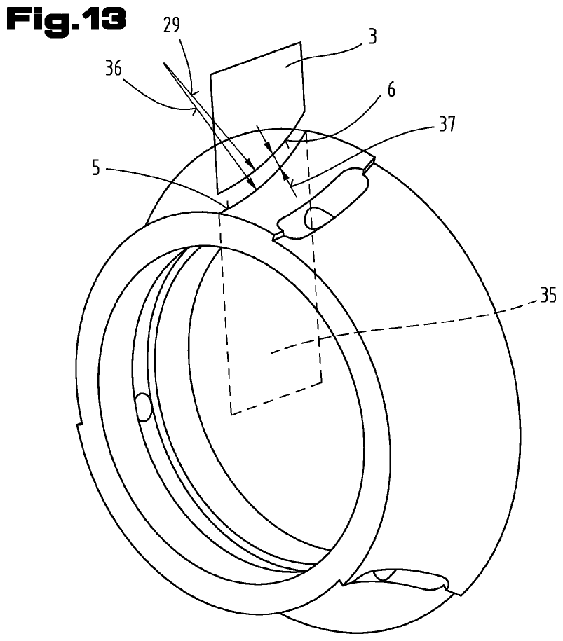

FIG. 13 a perspective view of the geometry in a special longitudinal section of the fifth embodiment of the inner ring element.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIGS. 1 to 4 display a first embodiment of individual parts and the assembly of a hydrodynamic sliding bearing 1. The following description refers to an overall view of the single figures.

As seen in FIG. 1, the hydrodynamic sliding bearing 1 comprises an inner ring element 2. The hydrodynamic sliding bearing 1 also comprises an outer ring element 3. The inner ring element 2 and the outer ring element 3 can be rotatable relative to each other about an axis of rotation 4.

In the first embodiment the outer ring element 3, which is displayed in detail in FIG. 3, has a sliding surface 5. The sliding surface 5 corresponds with a counter surface 6 situated on the inner ring element 2, which is displayed in detail in FIG. 4.

In the first embodiment, the inner ring element 2 is rotational symmetrical and has a first cylindrical section 7 and a second cylindrical section 8, wherein the counter surface 6 is situated between the first cylindrical section 7 and the second cylindrical section 8. A diameter of the second cylindrical section 8 can be greater than a diameter of the first cylindrical section 7. In this embodiment the counter surface 6 has a concave shape.

In the first embodiment, the sliding surface 5 of the outer ring element 3 has a convex shape. The sliding surface 5 of the outer ring element 3 can comprise a fist lobe 9, a second lobe 10, and a third lobe 11.

As seen in FIG. 3, in axial extension, the first lobe 9 has a varying first radial distance 12 to the axis of rotation. The first radial distance 12 could not only be varying in axial extension, but also in circumferential extension.

In the first embodiment, a lubricant supply groove 13 is formed by a step between the first lobe 9 and the second lobe 10. Generally speaking between each of the lobes 9, 10, 11 one of the lubricant supply grooves 13 could be situated.

In axial direction an edge 14 of the lubricant supply groove 13 can have a varying second radial distance 15 to the axis of rotation 4.

It is also possible, that a lubricant distribution groove 16 overlies the lubricant supply groove 13. The lubricant distribution groove 16 could extend only partially in an axial extension of the sliding surface 5. Further it is possible that every lubricant supply groove 13 is equipped with a lubricant distribution groove 16.

As displayed, it also possible, that a lubricant supply bore 17 opens into the lubricant supply groove 13. In other words, the lubricant supply bore 17 could open into the lubricant distribution groove 16.

FIG. 5 shows a second exemplary embodiment of the outer ring element 3 in a perspective view, wherein again, equal reference numbers/component designations are used for equal parts as before in FIG. 3. In order to avoid unnecessary repetitions, it is pointed to/reference is made to the detailed description in FIG. 3 preceding it.

As seen in FIG. 5 it is possible, that the sliding surface 5 is segmented in circumferential direction and comprises a first segment 18 and a second segment 19. The first segment 18 and the second segment 19 can be seamlessly connected to each other. It is possible, that the outer ring element 3 is consisting of two half shells. In this case, the first segment 18 and the second segment 19 are each in form of a halved outer ring element 3. It is also possible that the sliding surface 5 is segmented in further segments.

FIGS. 6 and 7 show a third exemplary embodiment of the inner ring element 2 and the outer ring element 3, wherein again, equal reference numbers/component designations are used for equal parts as before in FIGS. 1 to 4. In order to avoid unnecessary repetitions, it is pointed to/reference is made to the detailed description in FIGS. 1 to 4 preceding it.

As it can be seen in FIGS. 6 and 7, the sliding surface 5 can be situated on the outer ring element 3 and the counter surface 6 can be situated on the inner ring element 2. The sliding surface 5 can have a concave shape. The counter surface 6 can have a convex shape.

FIGS. 8 and 9 show a fourth exemplary embodiment of the inner ring element 2 and the outer ring element 3, wherein again, equal reference numbers/component designations are used for equal parts as before in FIGS. 1 to 4. In order to avoid unnecessary repetitions, it is pointed to/reference is made to the detailed description in FIGS. 1 to 4 preceding it.

As it can be seen in FIGS. 8 and 9, the sliding surface 5 can be situated on the inner ring element 2 and the counter surface 6 can be situated on the outer ring element 3. The sliding surface 5 can have a convex shape. The counter surface 6 can have a concave shape.

FIGS. 10 and 11 show a fifth exemplary embodiment of the inner ring element 2 and the outer ring element 3, wherein again, equal reference numbers/component designations are used for equal parts as before in FIGS. 1 to 4. In order to avoid unnecessary repetitions, it is pointed to/reference is made to the detailed description in FIGS. 1 to 4 preceding it.

As it can be seen in FIGS. 10 and 11, the sliding surface 5 can be situated on the inner ring element 2 and the counter surface 6 can be situated on the outer ring element 3. The sliding surface 5 can have a concave shape. The counter surface 6 can have a convex shape.

FIG. 12 shows construction elements of the fifth exemplary embodiment of the inner ring element 2, wherein again, equal reference numbers/component designations are used for equal parts as before in FIGS. 1 to 4. In order to avoid unnecessary repetitions, it is pointed to/reference is made to the detailed description in FIGS. 1 to 4 preceding it.

As it can be seen in FIG. 12, the sliding surface 5 can be defined by a first non-circular shaped profile 20 and a second non-circular shaped profile 21. The first non-circular shaped profile 20 and the second non-circular shaped profile 21 could be in axial offset 22 to each other.

The first non-circular shaped profile 20 and the second non-circular shaped profile 21 are of different dimensions. In particular, the second non-circular shaped profile 21 could be a radial offset of the first non-circular shaped profile 20. The first non-circular shaped profile 20 and the second non-circular shaped profile 21 could be designed as tilted three lobe geometry. The first non-circular shaped profile 20 could be based on a first virtual base cycle 30. In a first minimum clearance point 32, the first lobe 9 could intersect with the first virtual base cycle 30. In a second minimum clearance point 33, the second lobe 10 could intersect with the first virtual base cycle 30. In a third minimum clearance point 34, the third lobe 11 could intersect with the first virtual base cycle 31. In the configuration of the fifth exemplary embodiment, the minimum clearance points 32, 33, 34 can be the radial outermost points of the first non-circular shaped profile 20.

The second non-circular shaped profile 21 could be based on a second virtual base cycle 31.

The geometry of the sliding surface 5 can be defined by an extrusion of the first non-circular shaped profile 20 merging into the second non-circular shaped profile 21 along guide paths 23, 24, 25, 26, 27, 28. The first guide path 23, the second guide path 24 and the third guide path 25 can each be situated on one of the edges 14 of the lubricant supply groves 13.

The fourth guide path 26 can be situated on the first minimum clearance point 32. The fifth guide path 27 can be situated on the second minimum clearance point 33. The sixth guide path 28 can be situated on the third minimum clearance point 34. The fourth guide path 26, the fifth guide path 27 and the sixth guide path 28 can therefore define a first radius 29 or main radius of the lobes of the sliding surface 5.

The geometry of the first non-circular shaped profile 20 of the fifth exemplary embodiment of the inner ring element 2 has a tilt of 0.166.

FIG. 13 shows the fifth exemplary embodiment of the inner ring element 2, wherein again, equal reference numbers/component designations are used for equal parts as before in FIGS. 1 to 4. In order to avoid unnecessary repetitions, it is pointed to/reference is made to the detailed description in FIGS. 1 to 4 preceding it. The inner ring element 2 as shown in FIG. 13 is constructed as described in connection with FIG. 12.

In FIG. 13 the special longitudinal section plane 35 is defined as intersecting with one of the minimum clearance points 32, 33, 34. In this special longitudinal section plane 35 the first radius 29 or main radius of the sliding surface 5 displayed.

In FIG. 13, also a cross section of the outer ring element 3 in the special longitudinal section plane 35 is displayed. As displayed, the special longitudinal section plane 35, the counter surface 6 has a second radius 36. The first radius 29 and the second radius 36 have a clearance 37 to each other. This clearance 37 defines the film thickness of the lubricant.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size. Clearances of the lobe design are exaggerated in the figures for illustrative purposes.

### LIST OF REFERENCE NUMBERS

1 hydrodynamic sliding bearing
2 inner ring element
3 outer ring element
4 axis of rotation
5 sliding surface
6 counter surface
7 first cylindrical section
8 second cylindrical section
9 first lobe
10 second lobe
11 third lobe
12 first radial distance
13 lubricant supply groove
14 edge of the lubricant supply grove
15 second radial distance
16 lubricant distribution groove
17 lubricant supply bore
18 first segment
19 second segment
20 first non-circular shaped profile
21 second non-circular shaped profile
22 axial offset
23 first guide path
24 second guide path
25 third guide path
26 fourth guide path
27 fifth guide path
28 sixth guide path
29 first radius
30 first virtual base cycle
31 second virtual base cycle
32 first minimum clearance point
33 second minimum clearance point
34 third minimum clearance point
35 special longitudinal section plane
36 second radius
37 clearance

1. A hydrodynamic sliding bearing (1) comprising:
an inner ring element (2);
an outer ring element (3), wherein the inner ring element (2) and the outer ring element (3) are rotatable relative to each other about an axis of rotation (4);
wherein either the inner ring element (2) or the outer ring element (3) has a sliding surface (5) and the other one of the inner ring element (2) or the outer ring element (3) has a counter surface (6) corresponding with the sliding surface (5),
wherein the sliding surface (5) has a non-circular shaped cross section and is tapered in axial extension.

2. The hydrodynamic sliding bearing (1) according to claim 1, wherein the cross section of the sliding surface (5) comprises a first lobe (9) and a second lobe (10), wherein in axial extension, the first lobe (9) has a varying first radial distance (12) to the axis of rotation (4).

3. The hydrodynamic sliding bearing (1) according to claim 2, wherein the first lobe (9) and the second lobe (10) when viewed in the cross-section are shaped as fixed circular arc segments.

4. The hydrodynamic sliding bearing (1) according to claim 2, wherein when viewed in the cross-section each one of the lobes (9, 10) has an offset or tilt to the axis of rotation (4).

5. The hydrodynamic sliding bearing (1) according to claim 2, wherein the first lobe (9) and the second lobe (10) are separated by a lubricant supply groove (13) extending in axial direction.

6. The hydrodynamic sliding bearing (1) according to claim 5, wherein a plurality of the lubricant supply grooves (13) are distributed as a regular circular pattern over the circumference of the sliding surface (5).

7. The hydrodynamic sliding bearing (1) according to claim 5, wherein the lubricant supply groove (13) extends over the entire axial extension of the sliding surface (5).

8. The hydrodynamic sliding bearing (1) according to claim 5, wherein a lubricant distribution groove (16) overlies the lubricant supply groove (13), the lubricant distribution groove (16) extending only partially in an axial extension of the sliding surface (5).

9. The hydrodynamic sliding bearing (1) according to claim 5, wherein the lubricant supply groove (13) is formed by a kink or a step between the first lobe (9) and the second lobe (10), wherein in axial direction an edge (14) of the lubricant supply groove (13) has a varying second radial distance (15) to the axis of rotation (4).

10. The hydrodynamic sliding bearing (1) according to claim 1, wherein the sliding surface (5) is a closed surface in circumferential direction, or that the sliding surface (5) is a closed surface in circumferential direction, which is penetrated by lubricant supply bores (17).

11. The hydrodynamic sliding bearing (1) according to claim 1, wherein the sliding surface (5) is segmented in circumferential direction and comprises a first segment (18) and a second segment (19), wherein the first segment (18) and the second segment (19) are seamlessly connected to each other.

12. The hydrodynamic sliding bearing (1) according to claim 1, wherein the counter surface (6) has a circular shaped cross section, and is tapered in axial direction.

13. The hydrodynamic sliding bearing (1) according to claim 12, wherein the counter surface (6) is tapered in axial direction in the form of a cone segment.

14. The hydrodynamic sliding bearing (1) according to claim 12, wherein the counter surface (6) is tapered in axial direction in the form of a spherical segment.

15. The hydrodynamic sliding bearing (1) according to claim 1, wherein the sliding surface (5) is tapered in axial direction in the form of a cone segment.

16. The hydrodynamic sliding bearing (1) according to claim 1, wherein the sliding surface (5) is arranged on the inner ring element (2) and has a convex shape in axial direction, or
that the sliding surface (5) is arranged on the inner ring element (2) and has a concave shape in axial direction.

17. The hydrodynamic sliding bearing (1) according to claim 1, wherein the sliding surface (5) is arranged on the outer ring element (3) and has a convex shape in axial direction, or
that the sliding surface (5) is applied on the outer ring element (3) and has a concave shape in axial direction.

18. The hydrodynamic sliding bearing (1) according to claim 1, wherein the non-circular shaped cross section of the sliding surface (5) has an elliptical shape, or the non-circular shaped cross section of the sliding surface (5) has an offset halved shape, or the non-circular shaped cross section of the sliding surface (5) has a pressure dam shape, or the non-circular shaped cross section of the sliding surface (5) has a multi-lobe shape, or the non-circular shaped cross section of the sliding surface (5) has a multi-pocket shape.

19. The hydrodynamic sliding bearing (1) according to claim 1, wherein a special longitudinal section plane (35), the sliding surface (5) has a first radius (29), and the counter surface (6) has a second radius (36), wherein the first radius (29) and the second radius (36) are offset to each other by a clearance (37), wherein the clearance (37) has a magnitude which is in the range of 0.00005 to 0.002 multiplied by the first radius (29).

20. The hydrodynamic sliding bearing (1) according to claim 19, wherein the special longitudinal section plane (35) is located at a circumferential distance of 10° to 30° to the lubricant supply groove (13).

21. A hydrodynamic sliding bearing (1) comprising:
an inner ring element (2);
an outer ring element (3), wherein the inner ring element (2) and the outer ring element (3) are rotatable relative to each other about an axis of rotation (4);
wherein either the inner ring element (2) or the outer ring element (3) has a sliding surface (5) and the other one of the inner ring element (2) or the outer ring element (3) has a counter surface (6) corresponding with the sliding surface (5),
wherein the sliding surface (5) comprises a first non-circular shaped profile (20) and a second non-circular shaped profile (21) being in axial offset (22) to each other, wherein the first noncircular shaped profile (20) and the second non-circular shaped profile (21) are of different dimensions, wherein the sliding surface (5) is an extrusion of the first non-circular shaped profile (20) merging into the second non-circular shaped profile (21) along guide paths (23, 24, 25, 26, 27, 28).

22. The hydrodynamic sliding bearing (1) according to claim 21, wherein
the first non-circular shaped profile (20) and the second non-circular shaped profile (21) of the sliding surface (5) have an elliptical shape, or
the first non-circular shaped profile (20) and the second non-circular shaped profile (21) of the sliding surface (5) have an offset halved shape, or
the first non-circular shaped profile (20) and the second non-circular shaped profile (21) of the sliding surface (5) have a pressure dam shape, or
the first non-circular shaped profile (20) and the second non-circular shaped profile (21) of the sliding surface (5) have a multi-lobe shape, or
the first non-circular shaped profile (20) and the second non-circular shaped profile (21) of the sliding surface (5) have a multi-pocket shape.
